(19) United States
(12) Patent Application Publication
(10) Pub. No.: US 2009/0010165 A1
(43) Pub. Date: Jan. 8, 2009

(54) APPARATUS AND METHOD FOR LIMITING PACKET TRANSMISSION RATE IN COMMUNICATION SYSTEM

(75) Inventors: Han-Seok KIM, Seoul (KR); Eun-Chan PARK, Seongnam-si (KR); Abhishek ROY, Suwon-si (KR); Ki-Back KIM, Seongnam-si (KR); Jae-Young KIM, Yongin-si (KR)

Correspondence Address: Jefferson IP Law, LLP, 1730 M Street, NW, Suite 807, Washington, DC, 20036, US

(73) Assignee: Samsung Electronics Cp. Ltd., Suwon-si (KR)

(21) Appl. No.: 12/168,390

(22) Filed: Jul. 7, 2008

(30) Foreign Application Priority Data
Jul. 6, 2007 (KR) 2007-68163

(51) Int. Cl. H04L 12/26

(52) U.S. Cl. 370/235

(57) ABSTRACT

In a communication system, a token manager corresponding to a generated or arriving packet is determined, tokens corresponding to a target transmission rate limit are generated, and a corresponding packet is at least one of dropped and provided in consideration of the amount of the tokens created and the size of the generated packet. Through such a method, a packet transmission rate can be limited to the target transmission rate. In addition, when there is traffic of various service classes, service can be differentially provided according to the priorities of the service classes.

### PRIORITY

This application claims the benefit under 35 U.S.C. § 119(a) of a Korean patent application filed in the Korean Intellectual Property Office on Jul. 6, 2007 and assigned Serial No. 2007-68163, the entire disclosure of which is hereby incorporated by reference.

### BACKGROUND OF THE INVENTION

1. Field of the Invention The present invention relates to a communication system. More particularly, the present invention relates to an apparatus and method for limiting a packet transmission rate in a communication system.

2. Description of the Related Art Internet service providers and communication providers limit a packet transmission rate by setting a maximum available packet transmission rate for a specific flow or a user-by-user flow. Limiting a maximum packet transmission rate restrains abnormal or excessive traffic from occurring, thereby preventing a communication network from becoming congested. Also, a packet transmission rate for high priority users may be established differently from a packet transmission rate for normal users, thereby increasing revenue through service differentiation. For this reason, algorithms of limiting a packet transmission rate must be treated with great importance in a communication network.

The algorithms of limiting a packet transmission rate may be classified into two types.

First, according to a limiting algorithm, incoming speeds of packets are monitored, and packets incoming at a speed equal to or greater than a preset threshold value are dropped, thereby controlling an incoming speed of a packet.

Second, according to a shaping algorithm, incoming packets are buffered, and are then provided at a preset speed, thereby controlling an outgoing speed of a packet.

The limiting algorithm drops packets incoming at a too high of a speed, in order to simplify implementation by not using buffers for each flow and complicated scheduling. However, the limiting algorithm has a disadvantage in that a resource utilization rate is degraded.

The shaping algorithm has an advantage of not dropping packets, but it requires a scheduling queue for each flow because a packet transmission rate must be adjusted for each individual flow. Accordingly, the shaping algorithm has disadvantages in that it is complicated to implement and a large amount of calculation is required for processing packets.

Therefore, there is a need for a new transmission-rate limiting algorithm capable of addressing the problems of the limiting algorithm and shaping algorithm. According to such need, various transmission-rate limiting algorithms have been proposed, but the conventional algorithms do not take the traffic characteristics of a Transmission Control Protocol (TCP) into consideration. Therefore, there is a further need to develop a new transmission-rate limiting algorithm that takes the traffic characteristics of the TCP into consideration.

Meanwhile, since the conventional algorithms are implemented without distinctions of service classes, when traffic comprising multiple service classes is multiplexed, traffic of a high service class may not be protected. Accordingly, for distinction of service classes, a transmission rate limitation operation may be individually performed for each service class. However, there are problems in that a bandwidth used for traffic corresponding to any one service class does not exist, and such a remaining bandwidth cannot be used for a different service class.

### SUMMARY OF THE INVENTION

An aspect of the present invention is to address at least the above-mentioned problems and/or disadvantages and to provide at least the advantages described below. Accordingly, an aspect of the present invention is to provide a system and method for limiting a packet transmission rate in a communication system.

In accordance with an aspect of the present invention, an apparatus for limiting a transmission rate of a packet in a communication system is provided. The apparatus includes a scheduler for creating tokens corresponding to a target transmission rate limit of the packet, and for at least one of dropping and providing the packet in consideration of an amount of the tokens created and a size of the packet.

In accordance with another aspect of the present invention, a method for limiting a transmission rate of a packet in a communication system is provided. The method includes creating an amount of tokens corresponding to a target transmission rate limit of the packet, and at least one of dropping and providing the packet in consideration of an amount of the tokens created and a size of the packet.

In accordance with still another aspect of the present invention, a method for packet scheduling in a communication system is provided. The method includes classifying one or more packets to be provided into classes, creating one or more tokens corresponding to a target transmission rate limit for each packet, and at least one of dropping and providing one or more packets of at least one class in consideration of threshold values set differently according to each of the classes when an amount of the tokens created is equal to or greater than a total size of the packets to be provided.

In accordance with still another aspect of the present invention, a method for limiting a packet transmission rate in a communication system is provided. The method includes classifying one or more packets to be provided into classes, creating one or more tokens corresponding to a target transmission rate limit for each packet, and at least one of dropping and providing one or more packets according to each class, in consideration of a threshold value equally set for all classes and packet dropping probabilities set differently depending on the classes, when an amount of the tokens created is equal to or greater than a total size of packets to be provided.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a view illustrating a configuration of a packet transmission rate limiting apparatus according to an exemplary embodiment of the present invention;

FIG. 2 is a flowchart illustrating an operation procedure by a transmission rate limiting algorithm according to an exemplary embodiment of the present invention;

FIG. 3 is a graph illustrating a relationship between an amount “b(t)” of available tokens and a packet dropping probability “p(t)” according to an exemplary embodiment of the present invention;

FIG. 4 is a flowchart illustrating an operation of limiting a transmission rate in consideration of classes of packets according to an exemplary embodiment of the present invention;

FIGS. 5A to 5C are graphs illustrating packet dropping probabilities “p(b, K)” for packets of each class “K” according to an amount “b” of available tokens, according to an exemplary embodiment of the present invention; and

FIGS. 6A and 6B are graphs illustrating throughputs according to classes which are obtained by applying an algorithm according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, description of well-known functions and constructions are omitted for clarity and conciseness.

Exemplary embodiments of the present invention provide an apparatus and method for limiting a packet transmission rate in consideration of traffic characteristics of a Transmission Control Protocol (TCP) and a case where traffic of various service classes exists.

The TCP is a representative protocol widely used in the Internet. When the conventional transmission-rate limiting algorithms are applied to a TCP flow, a system performance is degraded because of the reasons discussed below.

When a TCP transmission node detects a loss of a packet to transmit, the TCP transmission node reduces a packet transmission rate. That is, the TCP transmission node reduces a size of a congestion window to half of its previous size, or initializes the size of the congestion window to one. When the TCP transmission node receives an acknowledgement (ACK) signal for a transmitted packet, the TCP transmission node increases a packet transmission rate. That is, the TCP transmission node increases the size of the congestion window by a size of a transmission packet every time an ACK signal is received.

However, when a TCP intermediate node located between a TCP transmission node and a TCP reception node performs a transmission rate control using a packet-drop mechanism, a transmission rate may temporarily exceed a preset target transmission rate. In this case, a plurality of consecutive packets to be transmitted may be lost, thereby the TCP reception node will not receive packets for quite some time. In addition, a time-out situation occurs in the TCP transmission node, so that the TCP transmission node initializes a size of the congestion window to one.

As described above, whenever consecutive packets are lost, a time period during which a packet cannot be transmitted is doubled. That is, when the conventional packet transmission rate limiting schemes are applied to a TCP flow, the packet transmission rate exceeds a target transmission rate, is then considerably lower than the target transmission rate, and these phenomena are repeated. This causes a degradation of bandwidth use efficiency in a communication network.

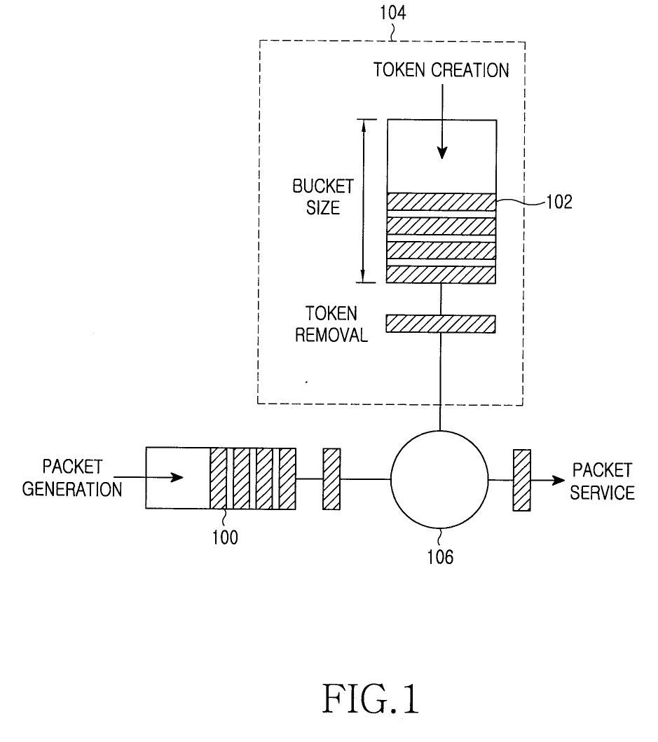

FIG. 1 is a view illustrating a configuration of a packet transmission rate limiting apparatus according to an exemplary embodiment of the present invention.

Referring to FIG. 1, the packet transmission rate limiting apparatus includes a packet queue 100 for storing a generated packet, a token bucket 102 for accumulating tokens, a token manager 104 for managing a creation and a destruction of tokens, and a packet dropper 106 for dropping a packet based on the number of available tokens.

A token represents a packet transmission right. The number of tokens created is the same as a number corresponding to a target transmission rate. The amount of tokens decreases by an amount corresponding to the size of a packet whenever the packet is provided. The size of the token bucket 102 is limited. If the number of tokens remaining in the token bucket 102 is less than the size of a generated packet when the generated packet is to be provided, a service of providing the packet is delayed until an available token is generated, or the packet is dropped.

Meanwhile, all packets are stored in one packet queue 100 regardless of a user the packet is associated with. In contrast, there is an individual token manager 104 for each user. That is, the number of tokens and token bucket parameters (e.g. a maximum size of a token bucket, a token creation speed, a threshold value, a packet dropping probability, etc.) must be managed according to each user.

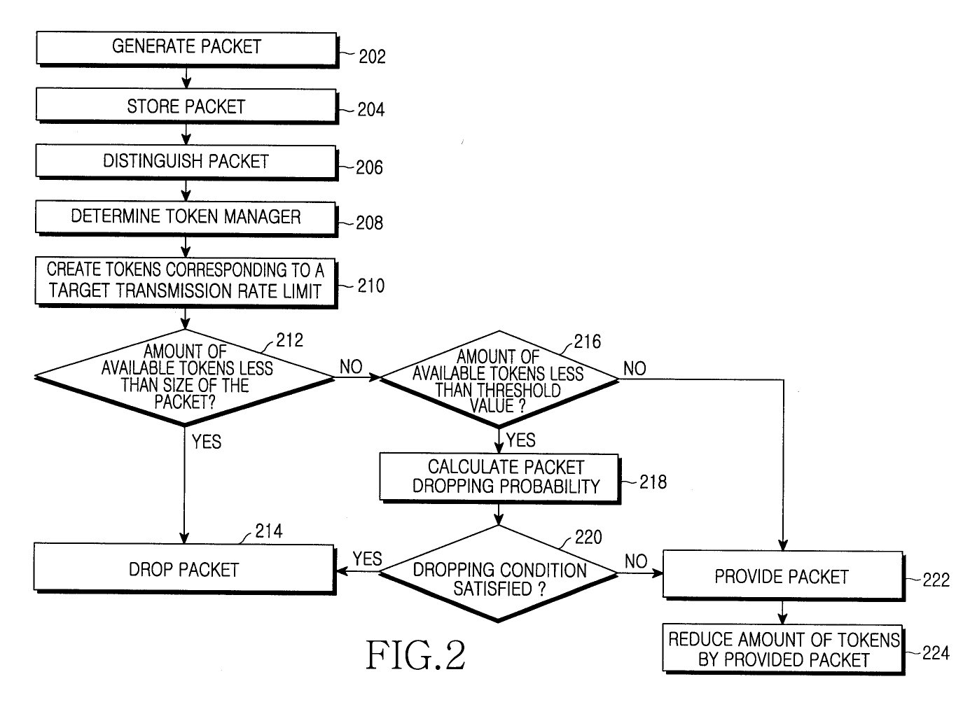

FIG. 2 is a flowchart illustrating an operation of limiting a transmission rate according to an exemplary embodiment of the present invention.

Referring to FIG. 2, in step 202, the transmission rate limiting apparatus generates a packet or recognizes the arrival of a packet, and proceeds to step 204. In step 204, the transmission rate limiting apparatus stores the generated or arriving packet in a packet queue, and proceeds to step 206. In step 206, the transmission rate limiting apparatus distinguishes the packet, and proceeds to step 208. In step 208, the transmission rate limiting apparatus determines a token manager corresponding to the distinguished packet, and proceeds to step 210.

In step 210, the transmission rate limiting apparatus creates a number of tokens wherein the number corresponds to a target transmission rate, and proceeds to step 212. Here, the number of tokens is used to mean the same as the amount of tokens. In step 212, the transmission rate limiting apparatus compares the amount of created tokens with the size of the packet. When the amount of tokens is less than the size of the packet to be provided, the transmission rate limiting apparatus proceeds to step 214, where the transmission rate limiting apparatus drops the corresponding packet. In contrast, when the amount of tokens is equal to or greater than the size of the packet to be provided, the transmission rate limiting apparatus proceeds to step 216.

In step 216, the transmission rate limiting apparatus compares the amount of available tokens with a preset threshold value. Here, the threshold value is used to calculate a packet dropping probability proposed in an exemplary embodiment of the present invention when the amount of available tokens is less than the threshold value, even if the amount of available tokens is equal to or greater than the size of a packet to be processed. Therefore, the unit of the threshold value is the same as that of the amount of tokens, and the threshold value must have a value greater than the size of a packet to be processed. That is, according to an exemplary embodiment of the present invention, a packet is provided in consideration of the threshold value and the packet dropping probability, which will be described later in more detail.

The transmission rate limiting apparatus proceeds to step 218 if it is determined that the amount of available tokens is less than the threshold value. In contrast, the transmission rate limiting apparatus proceeds to step 222 if it is determined that the amount of available tokens is equal to or greater than the threshold value. In step 218, the transmission rate limiting apparatus calculates a packet dropping probability, and then proceeds to step 220. In step 220, the transmission rate limiting apparatus determines if a drop condition is satisfied in consideration of the calculated packet dropping probability. When it is determined in step 220 that the drop condition is satisfied, the transmission rate limiting apparatus drops the corresponding packet in step 214. In contrast, when it is determined in step 220 that the drop condition is not satisfied, the transmission rate limiting apparatus provides the corresponding packet in step 222.

In step 222, since there are enough tokens to process the packet, the transmission rate limiting apparatus provides the corresponding packet, and then proceeds to step 224. In step 224, the transmission rate limiting apparatus decreases the amount of tokens by an amount corresponding to the size of the provided packet.

Hereinafter, a token management scheme and a packet dropping scheme will be described.

### Token Management Scheme

A token creation speed is the same as a target transmission rate, wherein whenever a packet is provided, the amount of tokens decreases by an amount corresponding to the size of the provided packet. Also, since the size of a token bucket is limited, a maximum number of available tokens is limited by the size of the token bucket. The above description may be expressed as below.

On every packet arrival
/* calculate inter-arrival time of two consecutive packets */
inter_arrival_time=current_time;
previous_packet_arrival_time;
/* generate token at the rate of target rate */
token=max (bucket depth, token+inter_arrival_time*target_rate);
previous_packet_arrival_time=current_time;
on every packet service
/* decrease token by amount of packet size */
token=token-packet_size;

### Packet Dropping Scheme

A difference between the transmission rate limiting algorithm, that is, a token bucket algorithm according to an exemplary embodiment of the present invention, and the conventional token bucket algorithm is as follows.

(1) Two threshold values are used to determine if a packet is dropped. That is, the size of a packet arriving at the packet queue in step 212 of FIG. 2 and the threshold value used in step 216 are used as threshold values for determining if the packet is dropped.

(2) Each packet is dropped probabilistically based on the amount of available tokens. That is, the conventional transmission rate limiting algorithm using a token bucket distinguishes only a case of providing a packet when the amount “b(t)” of available tokens is equal to or greater than the size “L” of the packet to be provided, and a case of dropping a packet when it is not. As a result, according to such a conventional transmission rate limiting algorithm, a plurality of consecutive packets may be lost at one time, which causes a considerable decrease of a packet processing rate.

In contrast, according to an exemplary embodiment of the present invention, even if the amount “b(t)” of available tokens is equal to or greater than the size “L” of a packet to be provided, the packet is dropped based on a probability value “p_o” less than one when the amount “b(t)” of available tokens is less than a threshold value “B_th,” which is different from the conventional transmission rate limiting algorithm.

A method of dropping a packet using a constant probability value “p_o” will now be described.

First, a random number having a value between zero and one is generated. When the generated random number is less than a packet dropping probability “p_o,” a corresponding packet is dropped, and when the generated random number is equal to or greater than a packet dropping probability “p_o,” a corresponding packet is provided. Otherwise, when each packet to be provided is generated, a counter value increases by one if the amount “b(t)” of available tokens is greater than the size “L” of the packet and is less than a threshold value “B_th” (i.e. when L<b(t)<B_th). Thereafter, when the counter value becomes 1/p_o, a corresponding packet is dropped. After the corresponding packet is dropped, the counter value is initialized to zero. That is, every “1/p_o” number of packets, one packet is dropped.

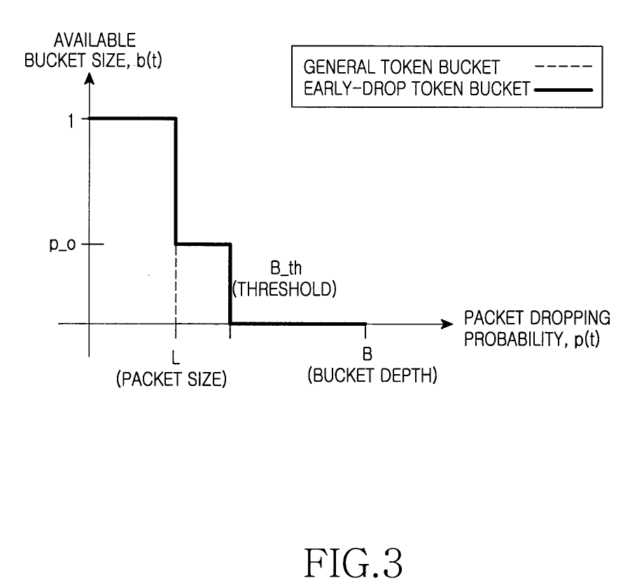

FIG. 3 is a graph illustrating a relationship between an amount “b(t)” of available tokens and a packet dropping probability “p(t)” according to an exemplary embodiment of the present invention.

When L<b(t)<B_th, a fixed packet dropping probability of “p(t)=p_o” is obtained. The p(t) is inversely proportional to the b(t), wherein it is established that the p(t) has a value of zero when the b(t) is equal to the B_th.

The p_o may be obtained from a relation between a transmission-rate-related equation of a TCP flow and a packet dropping probability value. According to a mathematical analysis, as a transmission rate increases, and as a Round Trim Time (RTT) increases, the p_o has a lower value. Also, the p_o is not changed whenever each packet is generated, but is set to a fixed value in consideration of an RTT of a TCP flow when a provider establishes a transmission rate limit.

The above description refers to a transmission rate limiting algorithm taking the TCP traffic characteristics into consideration. Hereinafter, a method of dropping packets according to each class will be described.

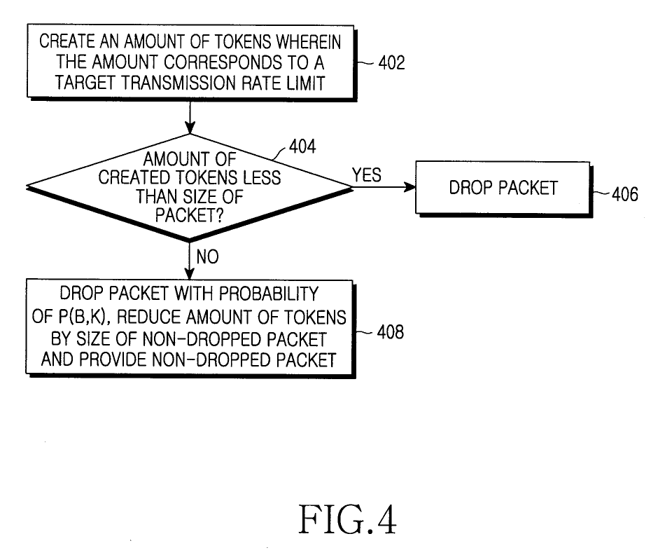

FIG. 4 is a flowchart illustrating an operation of limiting a transmission rate in consideration of classes of packets according to an exemplary embodiment of the present invention.

When packets arrive at a packet queue, a transmission rate limiting apparatus creates an amount of tokens wherein the amount corresponds to a target transmission rate limit in step 402, and proceeds to step 404. When it is determined in step 404 that the amount of available tokens is less than the size of arriving packets, the transmission rate limiting apparatus drops the packets in step 406. In contrast, when the amount of available tokens is equal to or greater than the size of the arriving packets, the transmission rate limiting apparatus performs a packet dropping operation based on a packet dropping probability “p(b, K)” considering the classes of packets, decreases the amount of tokens by an amount corresponding to the size of non-dropped packets, and provides the non-dropped packets in step 408. In the packet dropping probability, “b” represents the amount of available tokens remaining in the token bucket, and “K” represents the class of a packet.

That is, according to an exemplary embodiment of the present invention, the threshold value for tokens and the packet dropping probability, which are criteria for packet dropping, vary depending on the classes of packets. In contrast from an exemplary embodiment of the present invention, the conventional transmission rate limiting algorithm uses a fixed threshold value and a fixed dropping probability, without a distinction of classes.

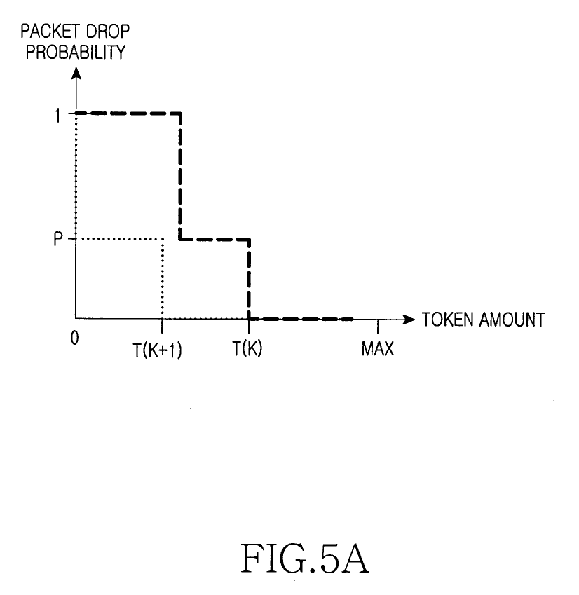

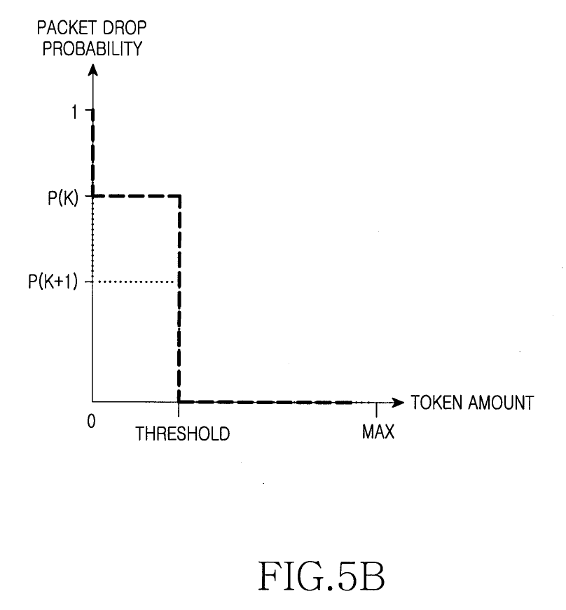

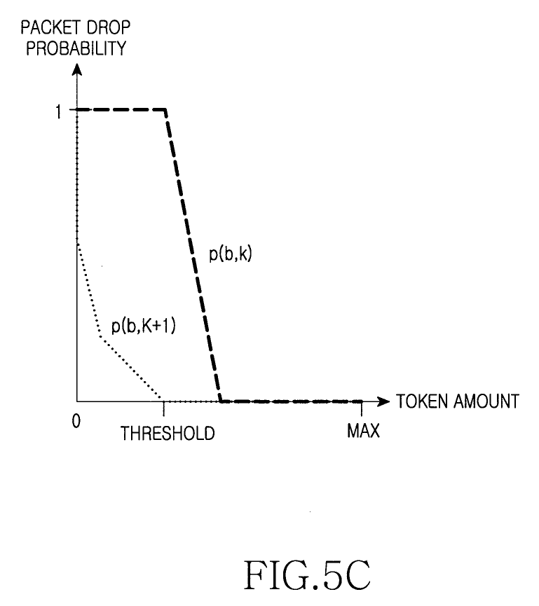

Packet dropping probabilities “p(b, K)” for packets of each class “K” according to the amount “b” of available tokens are illustrated as graphs in FIGS. 5A to 5C. In FIGS. 5A to 5C, it is assumed that packets of class “K+1” belong to a higher class than packets of class “K.”

FIG. 5A shows a graph illustrating packet dropping probabilities in which different threshold values are set depending on packet classes. That is, the packet dropping probabilities are set as a step function, and a threshold value (i.e. T(K+1)) for packets of a higher class is lower than a threshold value (i.e. T(K)) for packets of a lower class.

A relationship between threshold values and packets will now be described again with reference to the amount of created tokens. When tokens corresponding to a class lower than T(K+1) are created, packets of class T(K+1) are dropped with the probability of “P,” and packets of class T(K) are dropped with the probability of one. When tokens are generated corresponding to a class which is higher than T(K+1) and lower than T(K), packets of class T(K+1) are not dropped, and packets of class T(K) are dropped with the probability of “P” or one.

FIG. 5B shows a graph illustrating packet dropping probabilities differently set according to classes. That is, packets have the same threshold value regardless of classes thereof, but the dropping probability for packets of a higher class is lower than that for packets of a lower class. Accordingly, the probability that packets of a higher class are to be provided is higher than the probability that packets of a lower class are to be provided.

FIG. 5C is a graph illustrating a case where different packet dropping probabilities and different threshold values, depending on classes, are set in the form of a preset function.

As described above, the transmission rate limiting algorithm proposed by an exemplary embodiment of the present invention can increase the probability that packets of a higher class are to be provided while limiting the overall transmission rate to a set target speed. Such an algorithm can be applied to cases where a line concentrator or base station needs to limit transmission rates according to input ports while supporting a distinction of service classes.

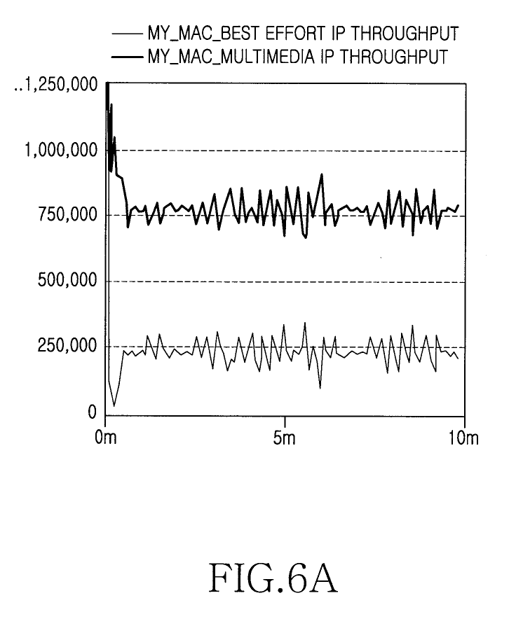

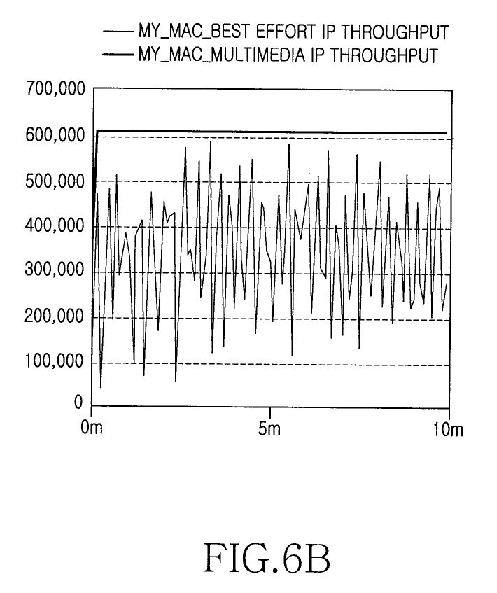

FIGS. 6A and 6B are graphs illustrating throughputs according to classes which are obtained by applying the algorithm according to an exemplary embodiment of the present invention. This simulation is performed under an environment where a transmission rate limiting value is 1 Mbps.

The graph of FIG. 6A is obtained using TCP packets which are assumed to have the characteristics that there is no transmission rate limit for higher and lower classes, and the TCP packets are to be provided as fast as possible. FIG. 6A shows that throughput for the higher class is higher than that for the lower class. That is, the throughput for the higher class is approximately 750 kbps, while the throughput for the lower class is approximately 250 kbps.

Referring to FIG. 6B, when a higher class corresponds to a User Datagram Protocol (UDP) input at a fixed speed of 600 kbps, and a lower class corresponds to a TCP, packets of the higher class are guaranteed to be provided.

As described above, the apparatus and method according to exemplary embodiments of the present invention can limit a packet transmission rate in consideration of the characteristics of the TCP traffic in a communication system. Accordingly, the apparatus and method according to exemplary embodiments of the present invention can reduce the complexity of implementation while increasing the utilization of resources in a communication system, and can also reduce the amount of calculation required for packet processing.

While the invention has been shown and described with reference to certain exemplary embodiments thereof, it will be understood by those skilled in the art that various changes in form and details may be made therein without departing from the spirit and scope of the invention as defined by the appended claims and their equivalents. Accordingly, the scope of the invention is not to be limited by the above exemplary embodiments but by the claims and their equivalents.

What is claimed is:

1. A method for limiting a transmission rate of a packet in a communication system, the method comprising:
creating an amount of tokens corresponding to a target transmission rate limit of the packet; and
at least one of dropping and providing the packet in consideration of an amount of the tokens created and a size of the packet.

2. The method as claimed in claim 1, wherein the at least one of the dropping and the providing of the packet in consideration of the amount of the tokens created and the size of the packet comprises dropping the packet when the amount of the tokens created is less than the size of the packet.

3. The method as claimed in claim 1, wherein the at least one of the dropping and the providing of the packet in consideration of the amount of the tokens created and the size of the packet comprises:
comparing the amount of the tokens created with a preset threshold value when the amount of the tokens created is equal to or greater than the size of the packet;
calculating a dropping probability for the packet when the amount of the tokens created is less than the threshold value;
dropping the packet when the calculated dropping probability satisfies a dropping condition for the packet; and
providing the packet when the calculated dropping probability does not satisfy the dropping condition for the packet.

4. The method as claimed in claim 1, wherein the at least one of the dropping and the providing of the packet in consideration of the amount of the tokens created and the size of the packet comprises:
providing the packet when the amount of the tokens created is equal to or greater than a threshold value; and
reducing the amount of the tokens created corresponding to the size of the provided packet.

5. An apparatus for limiting a transmission rate of a packet in a communication system, the apparatus comprising a scheduler for creating tokens corresponding to a target transmission rate limit of the packet, and for at least one of dropping and providing the packet in consideration of an amount of the tokens created and a size of the packet.

6. The apparatus as claimed in claim 5, wherein the scheduler drops the packet when the amount of the tokens created is less than the size of the packet.

7. The apparatus as claimed in claim 5, wherein the scheduler compares the amount of the tokens created with a preset threshold value when the amount of the tokens created is equal to or greater than the size of the packet, calculates a dropping probability for the packet when the amount of the tokens created is less than the threshold value, drops the packet when the calculated dropping probability satisfies a dropping condition for the packet, and provides the packet when the calculated dropping probability does not satisfy the dropping condition for the packet.

8. The apparatus as claimed in claim 5, wherein the scheduler provides the packet when the amount of the tokens created is equal to or greater than a threshold value, and decreases the amount of the tokens created by an amount corresponding to the size of the provided packet.

9. A method for packet scheduling in a communication system, the method comprising:
classifying one or more packets to be provided into classes;
creating one or more tokens corresponding to a target transmission rate limit for each packet; and
at least one of dropping and providing one or more packets of at least one class in consideration of threshold values set differently according to each of the classes when an amount of the tokens created is equal to or greater than a total size of the packets to be provided.

10. The method as claimed in claim 9, further comprising dropping one or more packets when the amount of the corresponding tokens created is less than the size of the one or more packets.

11. The method as claimed in claim 9, wherein the at least one of the dropping and the providing of the one or more packets of each class in consideration of threshold values set differently according to each of the class comprises:
setting the threshold value for any packet of a higher class to a value less than a threshold value for any packet of a lower class; and
at least one of dropping and providing a corresponding packet in consideration of a dropping probability for any packet of the higher class when the amount of the tokens created is less than the threshold value for any packets of the higher class,
wherein the dropping probability for any packet of the higher class is less than the dropping probability for any packet of the lower class.

12. The method as claimed in claim 11, further comprising, when the amount of the tokens created is equal to or greater than the threshold value for any packet of the higher class, and is less than the threshold value for any packet of the lower class, providing one or more packets corresponding to the higher class, and at least one of dropping and providing packets corresponding to the lower class in consideration of the dropping probability preset for any packet of the lower class.

13. The method as claimed in claim 12, wherein each dropping probability for any packet has a value within a range of 0 to 1.

14. The method as claimed in claim 11, further comprising providing all packets of the higher and lower classes when the amount of the tokens created is equal to or greater than the threshold value for any packet of the lower class.

15. A method for limiting a packet transmission rate in a communication system, the method comprising:
classifying one or more packets to be provided into classes;
creating one or more tokens corresponding to a target transmission rate limit for each packet; and
at least one of dropping and providing one or more packets according to each class, in consideration of a threshold value equally set for all classes and packet dropping probabilities set differently depending on the classes, when an amount of the tokens created is equal to or greater than a total size of packets to be provided.

16. The method as claimed in claim 15, further comprising dropping a one or more packets when the amount of the corresponding tokens created is less than the size of the one or more packets.

17. The method as claimed in claim 15, wherein the dropping probability for a higher class is lower than dropping probability for a lower class.

18. The method as claimed in claim 15, further comprising reducing the amount of the tokens created corresponding to a size of the one or more packets when the one or more packets are provided.
